(19) United States
(12) Patent Application Publication
(10) Pub. No.: US 2006/0076066 A1
(43) Pub. Date: Apr. 13, 2006

(54) Fluid control valve

(76) Inventor: Theodore J. Tine JR., Chester, CT (US)

Correspondence Address: THE LAW OFFICES OF STEVEN MCHUGH, LLC, 46 WASHINGTON STREET, MIDDLETOWN, CT, 06457, US

(21) Appl. No.: 11/117,842

(22) Filed: Apr. 28, 2005

Related U.S. Application Data
(60) Provisional application No. 60/565,906, filed on Apr. 28, 2004.

(51) Int. Cl. F16K 11/074

(52) U.S. Cl. 137/625.46

(57) ABSTRACT

A fluid control valve is provided and includes a valve body, wherein the valve body includes a valve inlet and a valve outlet communicated via a body cavity, a filtering device, a selection drum, wherein the selection drum includes a drum main inlet, a drum main outlet, a drum reserve inlet and a drum reserve outlet, wherein the drum main inlet is communicated with the drum main outlet via a drum main flow channel and wherein the drum reserve inlet is communicated with the drum reserve outlet via a drum reserve flow channel, at least one drum positional device and at least one body positional device, wherein the selection drum is movably disposed within the body cavity such that the selection drum is configurable into at least one predefined configuration, wherein when the selection drum is in the at least one predefined configuration the at least one drum positional device is seatingly associated with the at least one body positional device

### RELATED APPLICATIONS

This Application claims priority to U.S. Provisional Patent Application No. 60/565,906 filed Apr. 28, 2004 the contents of which are hereby incorporated by reference herein.

### FIELD OF THE INVENTION

This invention relates to a device for controlling the flow of a fluid and more particularly to a device for controlling the flow of fluidic fuel in a small vehicle such as a motorcycle.

### BACKGROUND OF THE INVENTION

The typical motorcycle design generally includes a fuel tank disposed above the engine and just forward of the motorcycle seat or saddle. The fuel tank usually includes at least one fuel bladder for holding fuel and a fuel flow controller, or fuel valve or petcock, connected to the bottom portion of the fuel tank wherein the fuel valve is configurable between an “ON” configuration, an “OFF” configuration and a reserve or “RES” configuration. The configuration of the fuel valve is typically accomplished using a toggle'switch, round knob or lever. Additionally, the fuel valve includes a standpipe having a standpipe inlet and a standpipe outlet. The standpipe extends upwardly into the fuel tank to be disposed within the fuel bladder such that when the fuel bladder is full of fuel the standpipe is immersed in fuel. A hose or fuel line is connected between the fuel valve and the engine to allow for the fuel to be delivered to the engine via gravity feed.

When the motorcycle is being operated normally, the fuel valve is configured into the “ON” configuration and fuel is flowing into the standpipe inlet and out of the fuel valve to the engine. However, as the amount of fuel in the fuel tank decreases, the fuel level in the fuel tank begins to fall below the height of the standpipe inlet interrupting the flow of fuel to the engine. As such, the engine begins to sputter and eventually will cease to operate. In order to keep the engine running, the fuel flow to the engine must be restored. To accomplish this, the cyclist must reach down and actuate the valve toggle to configure the fuel valve into the “RES” configuration permitting the fuel remaining in the fuel bladder to flow into a reserve inlet and out of the fuel valve to the engine. Because the reserve inlet is disposed lower on the standpipe than the standpipe inlet, this acts to warn the cyclist that the fuel level in the fuel tank is low.

Unfortunately, several problems currently exist with current fuel valve designs. One problem occurs because the fuel valve is not visible to the cyclist when the cyclist is in the saddle. If the fuel flow is interrupted as the cyclist is operating the motorcycle, the cyclist must manually configure the valve from the “ON” configuration into the “RES” configuration using the valve toggle switch. Because the fuel valve is not visible to the cyclist during operation, this must be accomplished by the cyclist feeling and estimating the position of the toggle switch while steering with only one hand. If not accurately positioned in the “RES” position, an insufficient supply of fuel will be delivered to the engine causing the engine to become starved of fuel. This may cause the engine to stall and possibly become unstable resulting in an unsafe; and poor performance of the motorcycle. This will typically lead to the cyclist again bending over to reach the valve toggle until the valve is correctly positioned to supply the fuel demand of the engine. This introduces an additional unsafe factor into the riding and operation of the motorcycle.

### SUMMARY OF THE INVENTION

A fluid control valve is provided and includes a valve body, a filtering device, a selection drum, at least one drum positional device and at least one body positional device, wherein the valve body defines a body cavity for movably containing the selection drum such that the selection drum is configurable into a predefined configuration, wherein when the selection drum is in the predefined configuration the at least one drum positional device is seatingly associated with the at least one body positional device. It is contemplated that the predefined configuration includes at least one of an “ON” configuration, an “OFF” configuration and a “RESERVE” configuration.

A fluid control valve is provided and includes a valve body, wherein the valve body includes a valve inlet and a valve outlet communicated via a body cavity, a filtering device, a selection drum, wherein the selection drum includes a drum main inlet, a drum main outlet, a drum reserve inlet and a drum reserve outlet, wherein the drum main inlet is communicated with the drum main outlet via a drum main flow channel and wherein the drum reserve inlet is communicated with the drum reserve outlet via a drum reserve flow channel, at least one drum positional device and at least one body positional device, wherein the selection drum is movably disposed within the body cavity such that the selection drum is configurable into at least one predefined configuration, wherein when the selection drum is in the at least one predefined configuration the at least one drum positional device is seatingly associated with the at least one body positional device.

### BRIEF DESCRIPTION OF THE DRAWINGS

The foregoing and other features and advantages of the present invention will be more fully understood from the following detailed description of illustrative embodiments, taken in conjunction with the accompanying drawings in which:

FIG. 1 is an exploded view of a fuel valve, in accordance with an illustrative embodiment;

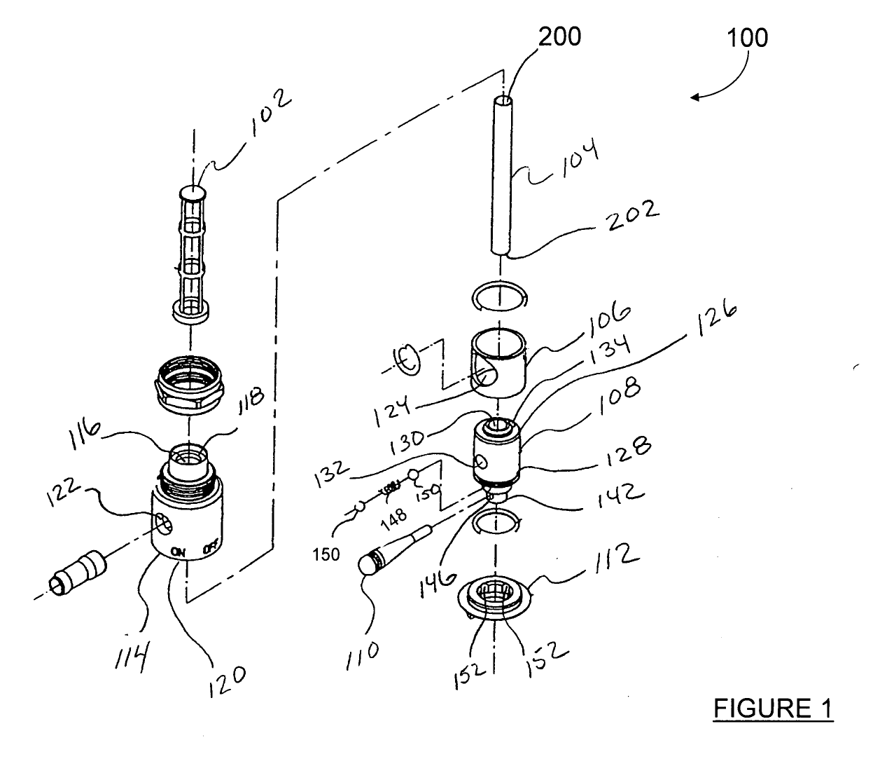

FIG. 2 is a multi-perspective view of a selection drum for the fuel valve of FIG. 1;

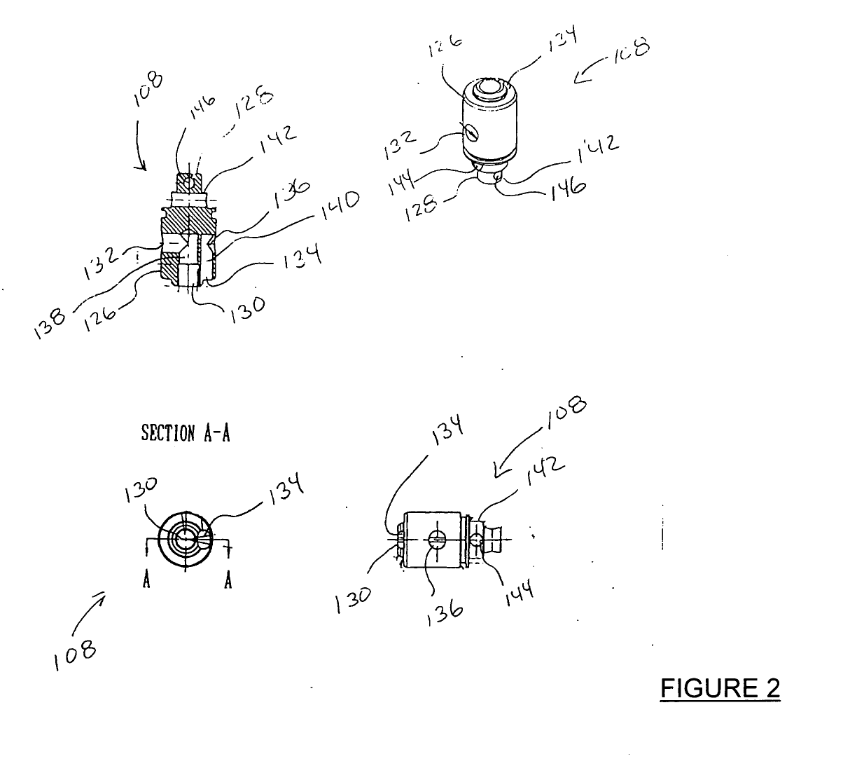

FIG. 3 is a multi-perspective view of a fuel valve cover for the fuel valve of FIG. 1;

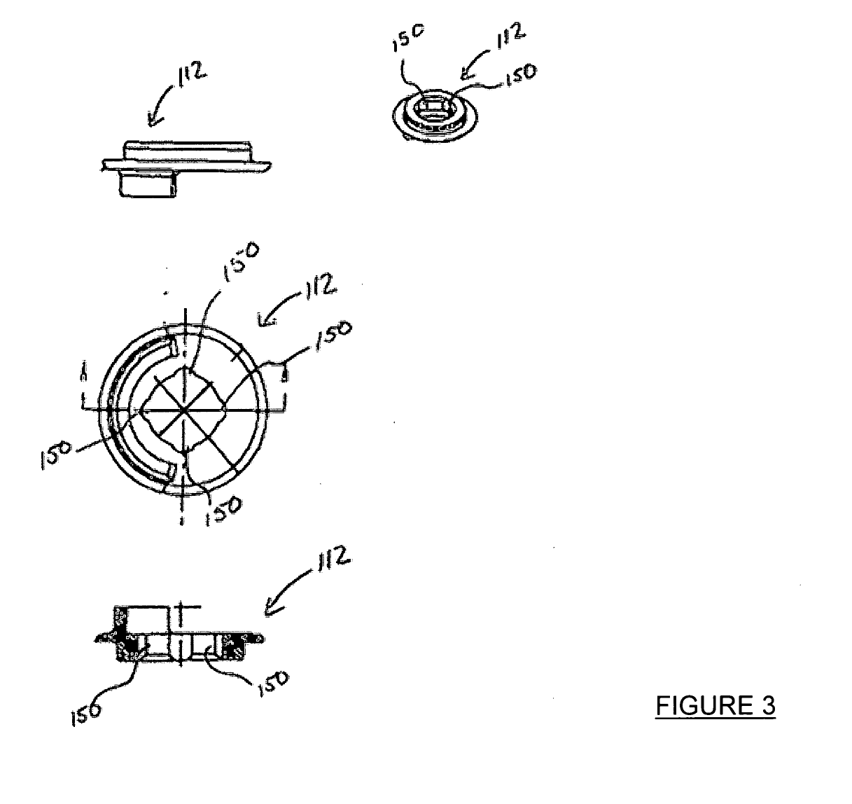

FIG. 4 is a multi-perspective view of a fuel valve liner for the fuel valve of FIG. 1;

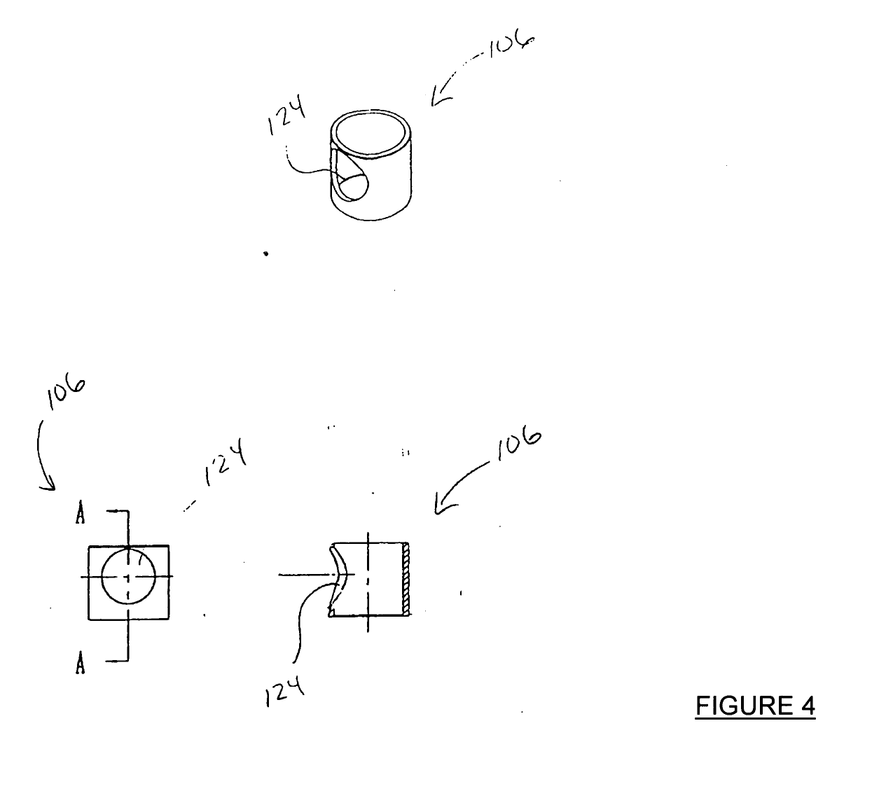

FIG. 5 is a side view of one alternative embodiment of a standpipe;

FIG. 6 is a side view of another alternative embodiment of a standpipe;

FIG. 7 is a side view of another alternative embodiment of a standpipe; and

FIG. 8 is a side view of one alternative embodiment of a drum lower portion having a round actuator knob.

### DETAILED DESCRIPTION OF THE INVENTION

Referring to the Figures, an illustrative embodiment of a fuel valve 100 is shown and includes a filtering device 102, a filter standpipe 104, a body liner 106, a selection drum 108, an actuation lever 110, a body drum cover 112 and a filter body 114. Filter body 114 defines a body cavity 116, a body filter port 118, a body drum port 120 and a fuel outlet port 122, wherein each of body filter port 118, body drum port 120 and fuel outlet port 122 are communicated with body cavity 114. Body liner 106, which includes a body liner opening 124, is disposed within body cavity 114 such that body liner opening 124 is communicated with fuel outlet port 122.

Selection drum 108 includes a drum upper portion 126, a drum lower portion 128, a drum main inlet 130, a drum main outlet 132, a drum reserve inlet 134 and a drum reserve outlet 136, wherein drum main inlet 130 is communicated with drum main outlet 132 via a drum main flow channel 138 and wherein drum reserve inlet 134 is communicated with drum reserve outlet 136 via a drum reserve flow channel 140. Filter standpipe 104, which includes a standpipe inlet 200 and a standpipe outlet 202, is associated with selection drum 108 such that standpipe outlet 202 is communicatedly associated with drum main inlet 130. Filtering device 102 is disposed over filter standpipe 104 such that fluid flowing into standpipe inlet 200 is filtered via filtering device 102.

Drum lower portion 128 includes a protruding drum portion 142 which defines an actuation cavity 144 and a lever cavity 146, each of which traverses the entire width of protruding drum portion 142. An actuator spring 148 and two actuation ball bearings 150 are disposed within actuation cavity 144 such that actuator spring 148 separates ball bearings 150 from each other and such that each of the two actuation ball bearings 150 compressibly protrude from actuation cavity 144. Actuation lever 110 is associated with lever cavity 146 such that actuation lever 110 protrudes from lever cavity 146. Selection drum 108 is movably disposed within body liner 106 such that the drum lower portion 128 is at least partially protruding from filter body 114. Body drum cover 112, which includes a plurality of actuation notches 152, is associated with filter body 114 such that protruding drum portion 142 at least partially protrudes from body drum cover 112 and such that each of the two actuation ball bearings 150 is seatingly associated with at least one of the plurality of actuation notches 152. It should be appreciated that although the embodiment described hereinabove discloses using an actuator spring 148 and two ball bearings 150 as an actuation device, it is within the scope of the embodiment that only one ball bearing 150 may be used and/or any actuation device suitable to the desired end purpose may be used, such as a compressible or retractable lever or clip.

Fuel valve 100 is associated with a fuel tank such that drum upper portion 126 is immerse in fuel contained within the fuel tank. As actuation lever 110, and hence selection drum 108, is rotated relative to filter body 114 the two actuation ball bearings 150 become disassociated with the two actuation notches 152 to which they were seatingly associated. If actuation lever 110 is moved a sufficient axial distance relative to filter body 114, then the two actuation ball bearings 150 become associated with two different notches of plurality of actuation notches 152. This allows for fuel valve 100 to seatlingly be in at least three different configurations: “ON”, “RESERVE” and “OFF”.

To configure fuel valve 100 into the “ON” configuration, actuation lever 110 is moved axially until the two actuation ball bearings 150 become seatingly associated with two of the plurality of actuation notches 152 and until drum main outlet 132 is communicated with fuel outlet port 122. To configure fuel valve 100 into the “OFF” configuration, actuation lever 110 is moved axially until the two actuation ball bearings 150 become seatingly associated with two of the plurality of actuation notches 152 and until neither drum main outlet 132 or drum reserve outlet 136 is communicated with fuel outlet port 122. To configure fuel valve 100 into the “RESERVE” configuration, actuation lever 110 is moved axially until the two actuation ball bearings 150 become seatingly associated with two of the plurality of actuation notches 152 and until drum reserve outlet 136 is communicated with fuel outlet port 122.

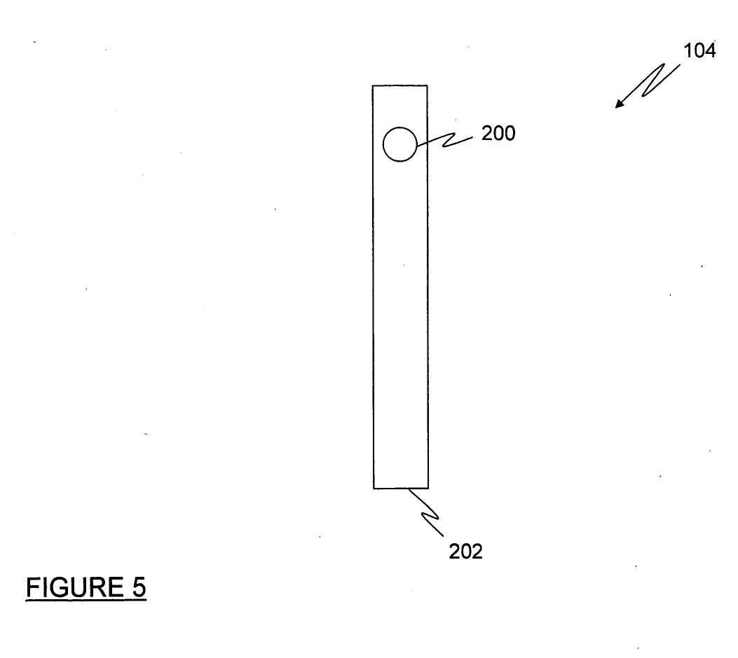

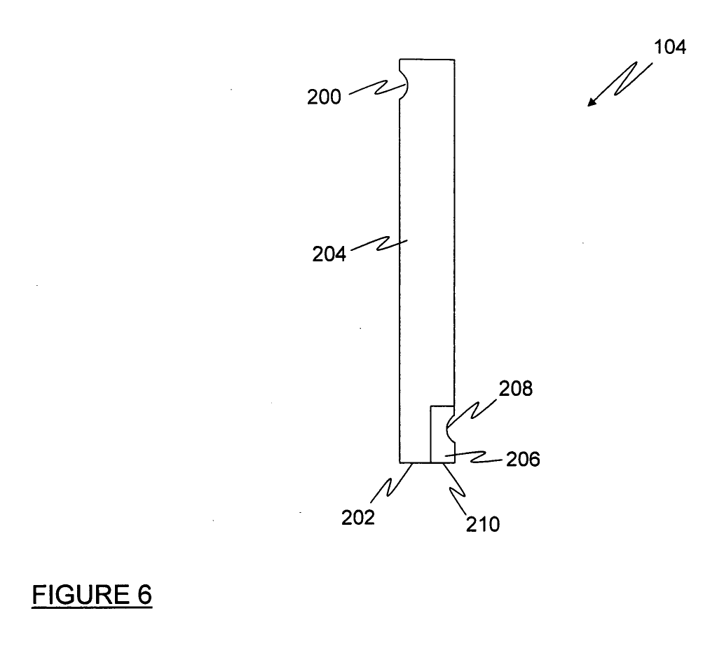

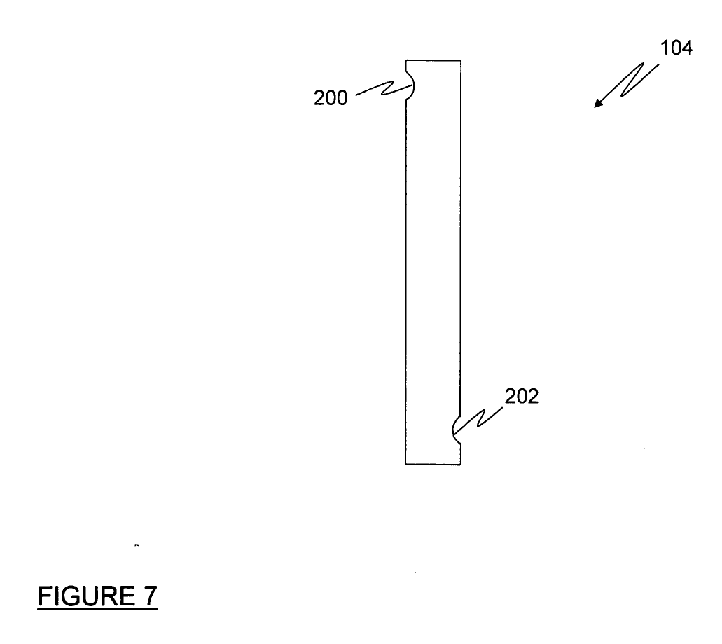

It should be appreciated that multiple alternate configurations of standpipe 104 may be used. Referring to FIG. 5, one configuration of standpipe 104 may include a standpipe inlet 200 disposed on a side portion of standpipe 104. Referring to FIG. 6, another embodiment of standpipe 104 is shown having a main channel 204 which communicates standpipe inlet 200 with standpipe outlet 202 and a reserve channel 206 which communicates a reserve inlet 208 with a reserve outlet 210. Referring to FIG. 7, another embodiment of standpipe 104 is shown having both the standpipe inlet 200 and the standpipe outlet 202 disposed on a side portion of standpipe 104.

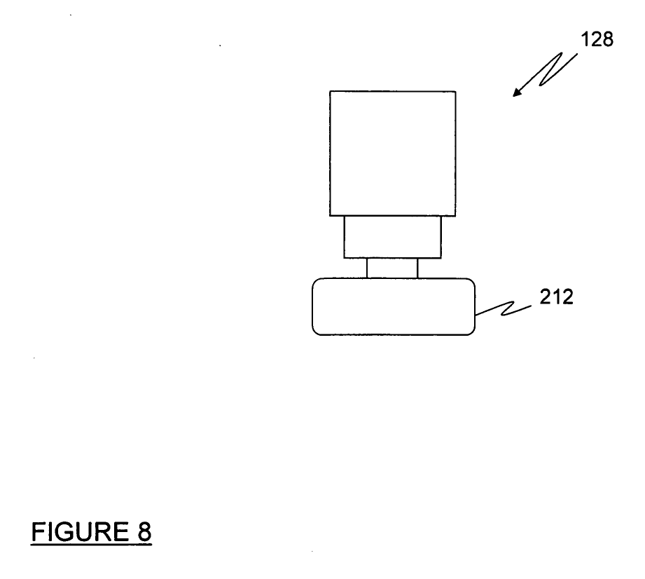

It should be further appreciated that multiple configurations of drum lower portion 128 may be used to actuate fuel valve 100. Referring to FIG. 8, one configuration of drum lower portion 128 may include a round knob 212 to actuate fuel valve 100.

While the disclosed embodiment has been described with reference to an exemplary embodiment, it should be understood by those skilled in the art that various changes, omissions and/or additions may be made and equivalents may be substituted for elements thereof without departing from the spirit and scope of the invention. In addition, many modifications may be made to adapt a particular situation or material to the teachings of the invention without departing from the scope thereof. Therefore, it is intended that the invention not be limited to the particular embodiment disclosed herein contemplated for carrying out this invention, but that the invention will include all embodiments falling within the scope and/or teachings of the appended sections, such as coolant fluid valves, hydraulic fluid valves, etc.

We claim:

1. A fluid control valve comprising:
a valve body;
a filtering device;
a selection drum;
at least one drum positional device; and
at least one body positional device, wherein said valve body defines a body cavity for movably containing said selection drum such that said selection drum is configurable into at least one predefined configuration, wherein when said selection drum is in said predefined configuration said at least one drum positional device is seatingly associated with said at least one body positional device.

2. A fluid control valve comprising:
a valve body, wherein said valve body includes a valve inlet and a valve outlet communicated via a body cavity;
a filtering device;
a selection drum, wherein said selection drum includes a drum main inlet, a drum main outlet, a drum reserve inlet and a drum reserve outlet, wherein said drum main inlet is communicated with drum main outlet via a drum main flow channel and wherein said drum reserve inlet is communicated with said drum reserve outlet via a drum reserve flow channel;
at least one drum positional device; and
at least one body positional device, wherein said selection drum is movably disposed within said body cavity such that the selection drum is configurable into at least one predefined configuration, wherein when said selection drum is in said at least one predefined configuration said at least one drum positional device is seatingly associated with said at least one body positional device.

3. The fluid control valve of claim 2, wherein said at least one predefined configuration includes a first predefined configuration, wherein when said selection drum is configured into said first predefined configuration, said drum main inlet is communicated with said valve inlet and said drum main outlet is communicated with said valve outlet.

4. The fluid control valve of claim 2, wherein said at least one predefined configuration includes a second predefined configuration, wherein when said selection drum is configured into said second predefined configuration, said drum reserve inlet is communicated with said valve inlet and said drum reserve outlet is communicated with said valve outlet.
